(19) United States
(12) Patent Application Publication
(10) Pub. No.: US 2026/0198733 A1
(43) Pub. Date: Jul. 16, 2026

(54) Toothpaste Storage and Dispensing Apparatus

(71) Applicant: Sherry Mays, Blytheville, AR (US)

(72) Inventor: Sherry Mays, Blytheville, AR (US)

(21) Appl. No.: 19/211,887

(22) Filed: May 19, 2025

Related U.S. Application Data
(60) Provisional application No. 63/745,757, filed on Jan. 15, 2025.

(51) Int. Cl. G06F 30/17; A47K 5/18; G06F 30/23

(52) U.S. Cl. CPC G06F 30/17; A47K 5/18; G06F 30/23

(57) ABSTRACT

A toothpaste or tooth gel dispensing device that comprises a refillable container integrated with a manually operable pump and actuator, enabling for controlled, one-handed (i.e., single handed) metered dispensing of toothpaste through an outlet nozzle is disclosed. The pump incorporates internal flow control components for mess-free operation and is removable to facilitate refilling. In another embodiment, the system comprises a detachable pump head configured to be mounted on a pressurized toothpaste container. The pump head includes a seal-breaking mechanism that actuates upon attachment, enabling toothpaste or tooth gel to be dispensed in a controlled amount under pressure via a user-operated actuator. The device supports clean, metered dispensing and can be adapted for various toothpaste viscosities and packaging types, offering an improved alternative to traditional toothpaste tubes.

### CROSS-REFERENCE TO RELATED APPLICATION

The present application claims priority to, and the benefit of, U.S. Provisional Application No. 63/745,575, which was filed on January 15, 2025, and is incorporated herein by reference in its entirety.

### FIELD OF THE INVENTION

The present invention generally relates to the field of oral care products. More specifically, the present invention relates to a toothpaste dispensing device configured for hygienic, controlled, and user-friendly application in both residential and travel scenarios. The device comprises a refillable container with an integrated manual pump. The device includes a lever-actuated pump mechanism with internal valves and a suction tube, enabling precise, one-handed (i.e., single handed) dispensing of toothpaste from a durable container. In one embodiment, the device has a detachable pump head, the pump head features a seal-breaking mechanism that actuates upon attachment to a pressurized container, facilitating immediate and clean dispensing. Accordingly, the present disclosure makes specific reference thereto. Nonetheless, it is to be appreciated that aspects of the present invention are also equally applicable to other like applications, devices, and methods of manufacture.

### BACKGROUND

By way of background, commonly, toothpaste is dispensed through a conventional collapsible tube, however, conventional means are often frustrating for many users. Traditional toothpaste tubes are typically made of flexible plastic or laminated metal and require manual squeezing to expel the contents. As the tube is used, extracting the remaining toothpaste becomes increasingly difficult, often requiring significant effort, rolling, or external tools to recover the final portions of the product. This not only results in inconvenience but frequently leads to waste, as users are unable to utilize all of the toothpaste within the tube.

In addition to inefficiency, conventional tubes are inherently messy. Residual toothpaste left around the cap or nozzle area can accumulate, dry out, and stain bathroom sinks or countertops. The lack of a controlled metered dispensing mechanism makes it difficult to regulate the quantity dispensed, especially for children, elderly users, or individuals with limited hand strength or dexterity. Furthermore, traditional toothpaste tubes are single-use and non-refillable. Once emptied, they are typically discarded, contributing to environmental waste and the ongoing demand for disposable packaging. Accordingly, individuals desire a more efficient, clean, and reusable alternative to the standard toothpaste tube for storing and dispensing toothpaste.

Therefore, there exists a long-felt need in the art for a toothpaste dispensing solution that obviates the common problems associated with traditional toothpaste tubes. There is a long-felt need for a device that enables clean, precise, and one-handed (i.e., single handed) dispensing of toothpaste without the need to squeeze, roll, or manipulate a deformable container. Additionally, there is a long-felt need for a hygienic, refillable, and eco-friendly toothpaste dispensing solution that can be reused and maintained with minimal effort. Furthermore, there is a long-felt need for a solution that provides users with a toothpaste dispenser designed like a liquid pump that dispenses toothpaste. More specifically, there is a long-felt need for a device that reduces mess and frustration associated with traditional toothpaste tubes. Finally, there is a long-felt need in the art for a toothpaste dispensing device that offers a cleaner and more convenient dispensing solution through a one-handed (i.e., single handed) method.

The subject matter disclosed and claimed herein, in one embodiment, comprises a refillable toothpaste pump device configured with an integrated lever-operated pump mechanism and suction tube. The device includes a refillable container to hold toothpaste and a built-in pump at its top end. A manually actuated lever compresses an internal spring to generate pressure, forcing toothpaste through a suction tube and out a one-way valve and nozzle for controlled metered dispensing. The pump prevents backflow and provides a metered output, reducing waste and avoiding spillage or overuse. The container can be easily refilled by unscrewing the pump and adding toothpaste, making it suitable for repeated long-term use and compatible with various toothpaste and/or tooth gel consistencies.

In another embodiment, the toothpaste pump device includes a detachable pump head compatible with a pressurized toothpaste or tooth gel cylinder. The pump head includes a seal-piercing mechanism that actuates upon attachment to the cylinder, enabling automatic dispensing when the lever is pressed. The detachable system enables easy replacement of spent cylinders, making the device efficient, hygienic, and ideal for both household and institutional use.

In this manner, the toothpaste pump device of the present invention fulfills the long-felt need for a mess-free, ergonomic, and sustainable toothpaste dispensing solution. The device is suitable for home use, travel, elderly care, and hospitality settings, offering a practical alternative to traditional tubes. The device enables one-handed (i.e., single handed) operation and reduces waste and eliminates messy residue. The device is available in refillable and commercial pressurized formats to accommodate needs of various users.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a toothpaste or tooth gel dispensing device. The toothpaste dispensing device comprises a container configured to store toothpaste or tooth gel, a pump is integrated with the container and is configured to dispense toothpaste therefrom, a manually operable lever is disposed on the pump and is configured to control the discharge of toothpaste through an outlet, wherein the container is refillable and the actuator enables one-handed (i.e., single handed) dispensing of the toothpaste.

In another aspect, a toothpaste dispensing pump device is disclosed. The toothpaste dispensing pump device includes a refillable toothpaste storage container configured to store toothpaste therein, an integrated pump is disposed at a top end of the container and is removably attachable thereto, a suction tube is operatively connected to the pump and extends toward a bottom of the container, a lever is operatively coupled to the pump and is configured to be manually pressed downward by a user, a spring is positioned within a pump chamber of the pump and is configured to compress upon actuation of the lever to generate pressure within the pump chamber, an outlet valve and an inlet valve are disposed within the pump, wherein the inlet valve prevents reverse flow of toothpaste or tooth gel into the container and the outlet valve enables toothpaste or tooth gel to exit the pump, a nozzle is positioned at a tip, or terminal end, of the lever for dispensing a controlled quantity of toothpaste/tooth gel in response to actuation of the lever, and wherein the pump is configured to dispense a predetermined volume of toothpaste per stroke and is lockable via a rotatable lever for secure storage and travel use.

In another embodiment, a toothpaste dispensing system is disclosed and comprises a pump head configured to removably attach to a pressurized toothpaste container, a lever is operatively coupled to the pump head for controlling the dispensing of toothpaste or tooth gel, a piercing or seal-breaking mechanism is associated with the pump head and is configured to open the pressurized container upon attachment, wherein the system is configured to dispense toothpaste through an outlet of the pump head when the actuator is operated.

In one embodiment, a toothpaste pump device is disclosed. The toothpaste pump device includes a detachable pump head which includes a discharge nozzle and a manually operable lever, a valve pin is disposed within the pump head, configured to pierce an internal seal of the pressurized toothpaste cylinder upon attachment of the pump head thereto, an internal valve is disposed within the pump head and is configured to control flow of toothpaste or tooth gel from the cylinder to the nozzle in response to actuation of the lever, wherein the toothpaste pump device enables controlled, one-handed (i.e., single handed) dispensing of toothpaste from the pressurized cylinder through the nozzle, and the pressurized cylinder is replaceable upon depletion.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a toothpaste or tooth gel pump device of the present invention in accordance with the disclosed structure;

FIG. 2 illustrates an enlarged view of the integrated pump used in the toothpaste pump device of the present invention in accordance with the disclosed structure;

FIG. 3 illustrates a perspective view showing the toothpaste pump device being refilled with toothpaste for reuse in accordance with the disclosed structure;

FIG. 4 illustrates a perspective view showing a user using the toothpaste pump device of FIG. 1 for dispensing toothpaste in accordance with one embodiment of the present invention;

FIG. 5 illustrates a perspective view of another embodiment of the toothpaste pump device of the present invention in accordance with the disclosed structure; and

FIG. 6 illustrates an internal view of the pump 502 and the cylinder of the toothpaste pump device of FIG. 5 in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a toothpaste dispensing solution that obviates the common problems associated with traditional toothpaste tubes. There is a long-felt need for a device that enables clean, precise, and one-handed (i.e., single handed) dispensing of toothpaste without the need to squeeze, roll, or manipulate a deformable container. Additionally, there is a long-felt need for a hygienic, refillable, and eco-friendly toothpaste dispensing solution that can be reused and maintained with minimal effort. Furthermore, there is a long-felt need for a solution that provides users with a toothpaste dispenser designed like a liquid pump that dispenses toothpaste or tooth gel. More specifically, there is a long-felt need for a device that reduces mess and frustration associated with traditional toothpaste tubes. Finally, there is a long-felt need in the art for a toothpaste or tooth gel dispensing device that offers a cleaner and more convenient dispensing solution through a one-handed method.

The present invention, in one exemplary embodiment, is a toothpaste pump device. The toothpaste pump device includes a detachable pump head which includes a discharge nozzle and a manually operable lever, a valve pin is disposed within the pump head, configured to pierce an internal seal of the pressurized toothpaste cylinder upon attachment of the pump head thereto, an internal valve is disposed within the pump head and is configured to control flow of toothpaste from the cylinder to the nozzle in response to actuation of the lever, wherein the toothpaste pump device enables controlled, one-handed (i.e., single handed) dispensing of toothpaste from the pressurized cylinder through the nozzle, and the pressurized cylinder is replaceable upon depletion.

Reference will now be made in detail to the present preferred embodiments of the invention, examples of which are illustrated in the accompanying drawings. Wherever possible, the same reference numerals are used in the drawings and the description to refer to the same or like parts.

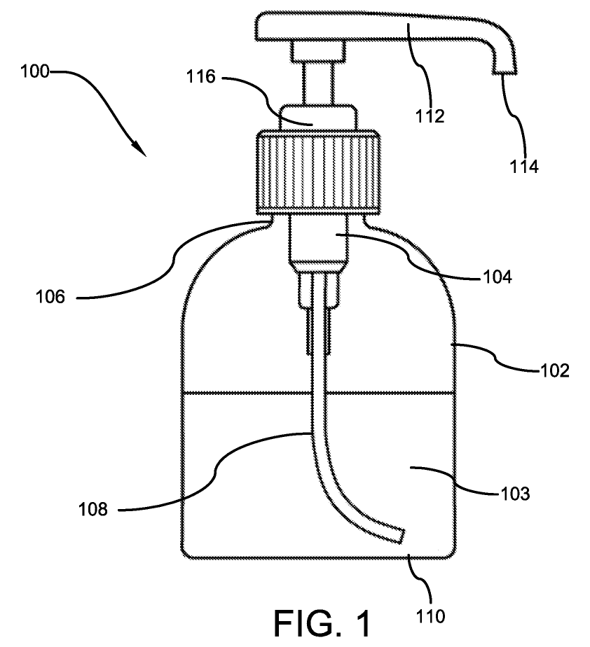

Referring initially to the drawings, FIG. 1 illustrates a perspective view of one potential embodiment of the toothpaste pump device of the present invention in accordance with the disclosed structure. The toothpaste pump device 100 of the present invention is designed as a toothpaste dispensing pump system to simplify, improve, and modernize the daily dispensing of toothpaste. The toothpaste pump device 100 enables one-handed (i.e., single handed) operation, reduces waste, and eliminates messy residue. More specifically, the toothpaste pump device 100 has a toothpaste storage container 102 which is durable, refillable, and is designed to hold toothpaste or tooth gel 103 therein. The toothpaste storage container 102 can be of any shape and size and can be designed as transparent, translucent, or opaque to accommodate requirements of various users.

The toothpaste pump device 100 includes an integrated metering pump 104 built into the top end or neck 106 of the container 102. The metering pump 104 is operatively connected to a suction tube 108 wherein the suction tube 108 is hollow and extends to the bottom 110 of the container 102. In one embodiment, the suction tube 108 having a diameter from 6.43 mm to 8.52 mm. In another embodiment, the suction tube 108 having a diameter from 7.20 mm to 8.02 mm. A lever 112 is disposed on the top of the metering pump 104 and is configured to be pushed down (i.e., compressed) by a user. When the lever 112 is pressed down, pressure inside the metering pump 104 increases to force the toothpaste 103 up through the suction tube 108 and the toothpaste or tooth gel 103 through a one-way outlet valve 116 in the metering pump 104, moves toward a nozzle 114 for dispensing. The nozzle 114 is positioned at the tip, or terminal end, of the lever 112 for precise and controlled metered dispensing of the toothpaste 103. In one embodiment, the nozzle 114 having a diameter from 6.43 mm to 8.52 mm. In another embodiment, the nozzle 114 having a diameter from 7.20 mm to 8.02 mm.

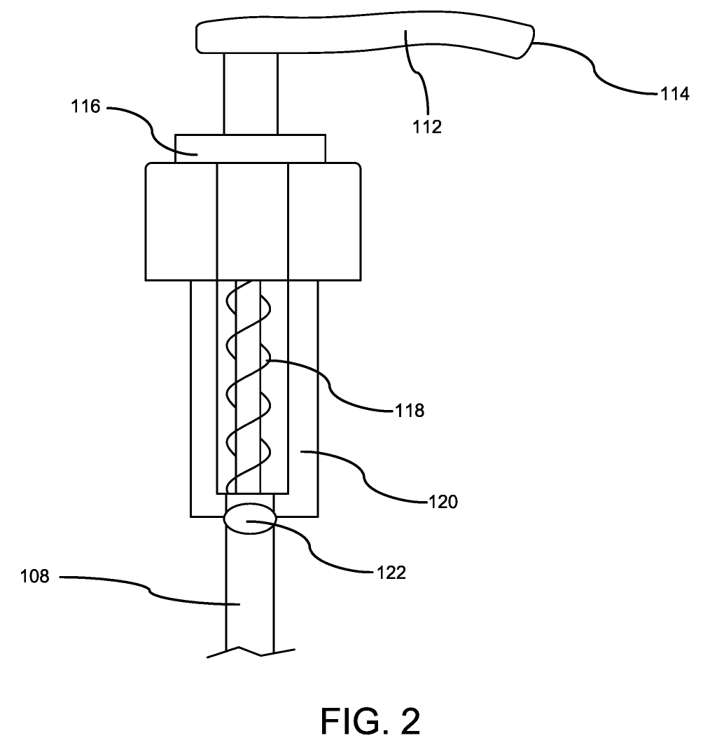

FIG. 2 illustrates an enlarged view of the integrated pump used in the toothpaste pump device of the present invention in accordance with the disclosed structure. The metering pump 104 includes a spring 118 inside a pump chamber 120 and when the lever 112 is pressed down, the spring 118 is compressed to increase the pressure inside the pump chamber 120. Due to increased pressure, the one-way inlet valve 122 does not enable (i.e., prohibits) the toothpaste to flow backward (downward) in the suction pump 104 and the outlet valve 116 is opened to dispense the toothpaste through the nozzle 114. When the lever 112 is released, the spring 118 is released and the outlet valve 116 closes, so the toothpaste is not dispensed.

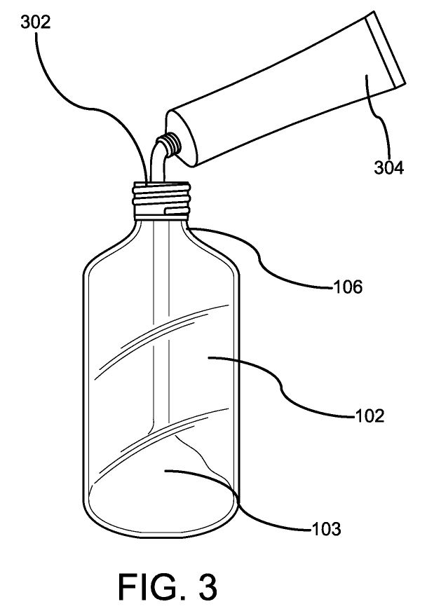

FIG. 3 illustrates a perspective view showing the toothpaste pump device being refilled with toothpaste for reuse in accordance with the disclosed structure. The container 102 of the pump device 100 can be refilled with any type of toothpaste 103 or other similar items, such as tooth gel, shampoo, or more, for reuse. The metering pump 104 along with the lever 112 can be removed from the top end 106 of the container 102, such as by unscrewing therefrom. The top opening 302 of the container 102 enables a user to refill the container 102 from any conventional toothpaste tube 304. It should be noted that the container 102, pump 104, suction tube 108, and the nozzle 114 are designed and dimensioned for thick toothpaste or tooth gel and to facilitate smooth and controlled metered dispensing of the toothpaste.

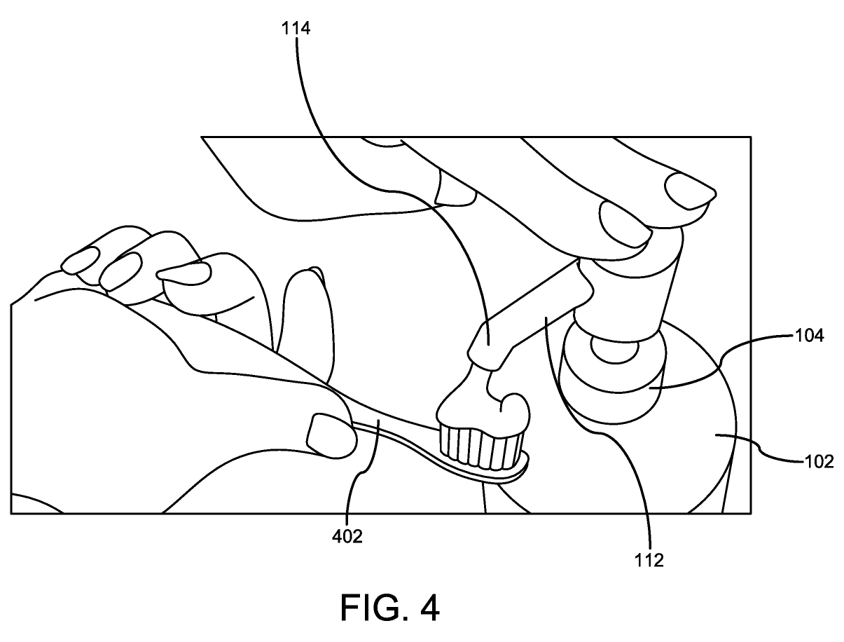

FIG. 4 illustrates a perspective view showing a user using the toothpaste pump device of FIG. 1 for dispensing toothpaste in accordance with one embodiment of the present invention. As illustrated, the lever 112 is pressed down to activate the metering pump 104 as described earlier in the disclosure and a controlled quantity of toothpaste is dispensed from the nozzle 114 on a toothbrush 402. It should be noted that the device 100 is designed and dimensioned to dispense a predetermined quantity of toothpaste on a single press of lever 112. In some embodiments, the lever 112 can be rotated 180 degrees to lock the lever 112 and prevent pressing down of the lever 112. The lever 112 in a locked position does not dispense toothpaste and can be used for storing the device 100 during travelling.

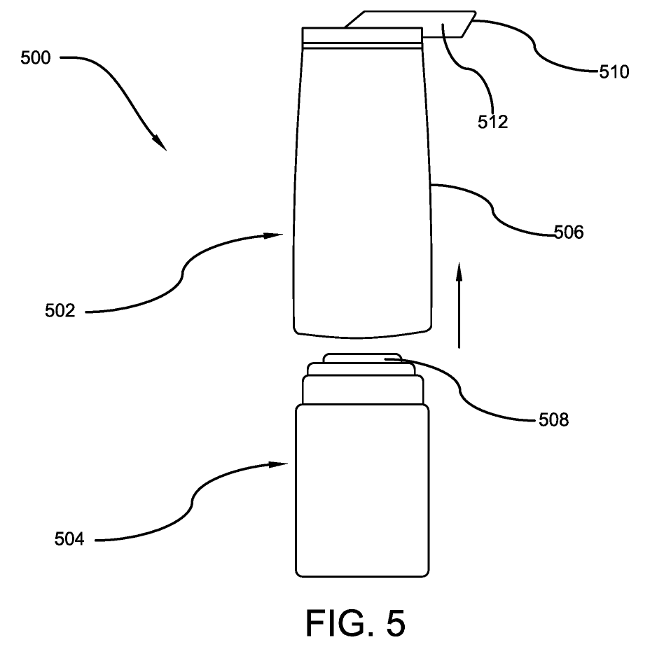

FIG. 5 illustrates a perspective view of another embodiment of the toothpaste pump device of the present invention in accordance with the disclosed structure. The toothpaste pump device 500 of the present embodiment is in the form of a combination of a detachable pump 502 and a pressurized toothpaste cylinder 504. The pump 502 includes a pump head 506 which is designed to screw onto the pressurized toothpaste cylinder 504. The cylinder 504 includes an internal seal 508 which is broken when the pump head 506 is screwed onto the cylinder 504, thereby enabling the toothpaste to flow from the cylinder 504 to the nozzle 510 of the pump 502. A lever 512 is pressed down to facilitate dispensing of the toothpaste from the nozzle 510.

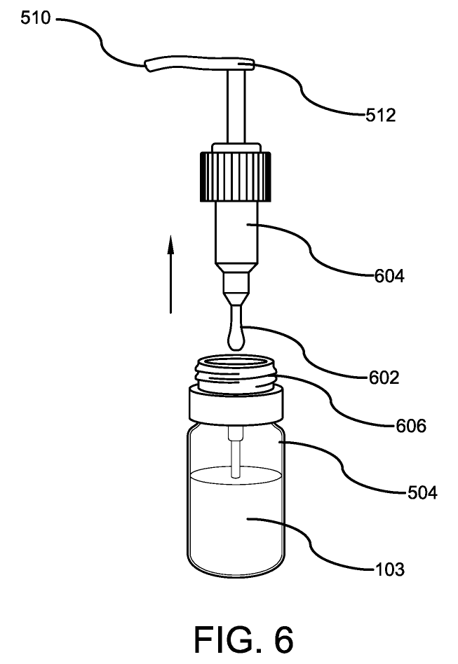

FIG. 6 illustrates an internal view of the pump 502 and the cylinder 504 of the toothpaste pump device of FIG. 5 in accordance with the disclosed structure. As illustrated, a valve pin 602 is included in the pump head 506 and is used for breaking the seal 508 of the cylinder 504 and helps in fastening of the pump head 506 and the cylinder 504. An internal valve 604 carries the toothpaste 103 from the cylinder 504 to the nozzle 510 when the lever 512 is pressed down by a user. The threaded collar 606 helps in securing the pump 502 and the cylinder 504 to function as a single unit. It should be noted that the cylinder 504 can be replaced with a new cylinder when toothpaste therein is exhausted.

The toothpaste pump devices of the present invention can be PET, HDPE, or PP plastic and the pressurized cylinder can be made from Aluminum or composite plastic. The toothpaste discharge (i.e., metered discharge amount or controlled quantity) per lever stroke, in one embodiment, can be in the range from about 1.00 g to about 2.00 g. The toothpaste metered discharge amount (i.e., controlled quantity) per lever stroke, in another embodiment, can be in the range from about 1.25 g to about 1.60 g. The toothpaste pump devices can store up to 400 g of toothpaste for use by a standard family. In some embodiments, the lever is manual but can also be touch-based or may include a proximity sensor for automatically dispensing a controlled quantity of toothpaste. The nozzle is designed to be anti-drop to prevent mess, and various valves are backflow prevention valves for eliminating contamination.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “toothpaste dispensing device”, “toothpaste pump device”, and “device” are interchangeable and refer to the portable toothpaste dispensing device 100, 500 of the present invention.

Notwithstanding the foregoing, the portable toothpaste dispensing device 100, 500 of the present invention can be of any suitable configuration as is known in the art without affecting the overall concept of the invention, provided that it accomplishes the above-stated objectives. One of ordinary skill in the art will appreciate that the portable toothpaste dispensing device 100, 500 as shown in the FIGS. are for illustrative purposes only, and that many other configurations of the portable toothpaste dispensing device 100, 500 are well within the scope of the present disclosure. Although the dimensions of the portable toothpaste dispensing device 100, 500 are important design parameters for user convenience, the portable toothpaste dispensing device 100, 500 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A single handed toothpaste pump dispenser comprising:
a pump dispenser having a storage container for holding toothpaste;
an integrated metering pump; and
a lever;
wherein said storage container having a material selected from the group consisting of a transparent material, a translucent material, and an opaque material;
wherein said integrated metering pump operatively connected to a suction tube including a one-way outlet valve;
wherein said suction tube extends to a bottom of said storage container;
wherein said lever mounted on a top of said integrated metering pump;
wherein compressing said lever actuates the dispensing of said toothpaste in a metered discharge amount from said storage container, through said suction tube and said one-way outlet valve, and out of a nozzle;
wherein said nozzle positioned at a terminal end of said lever for the dispensing of said toothpaste;
wherein said nozzle having a diameter from 6.43 mm to 8.52 mm;
wherein said suction tube having a diameter from 6.43 mm to 8.52 mm;
wherein the compressing of said lever increases a pressure inside said integrated metering pump for forcing said toothpaste through said suction tube; and
further wherein said storage container is refillable.

2. The single handed toothpaste pump dispenser of claim 1, wherein said metered discharge amount is from 1.00 g to 2.00 g.

3. The single handed toothpaste pump dispenser of claim 2, wherein said integrated metering pump having a spring inside a pump chamber.

4. The single handed toothpaste pump dispenser of claim 3, wherein the compressing of said lever compresses said spring and increases the pressure inside said pump chamber for limiting flow of said toothpaste in one direction.

5. The single handed toothpaste pump dispenser of claim 4, wherein said outlet valve is opened to dispense said toothpaste through said nozzle.

6. The single handed toothpaste pump dispenser of claim 5, wherein releasing said lever releases said spring and closes said one-way outlet valve for prohibiting flow of said toothpaste.

7. The single handed toothpaste pump dispenser of claim 6, wherein said nozzle having a diameter from 7.20 mm to 8.02 mm.

8. The single handed toothpaste pump dispenser of claim 7, wherein said suction tube having a diameter from 7.20 mm to 8.02 mm.

9. The single handed toothpaste pump dispenser of claim 8, wherein said toothpaste is tooth gel.

10. The single handed toothpaste pump dispenser of claim 9, wherein said integrated metering pump selectively removable from said storage container.

11. The single handed toothpaste pump dispenser of claim 10, wherein said metered discharge amount is from 1.25 g to 1.60 g.

12. A single handed toothpaste pump dispenser comprising:
a pump dispenser having a storage container for holding toothpaste;
an integrated metering pump; and
a lever;
wherein said storage container having a material selected from the group consisting of a transparent material, a translucent material, and an opaque material;
wherein said integrated metering pump operatively connected to a suction tube including a one-way outlet valve;
wherein said suction tube extends to a bottom of said storage container;
wherein said lever mounted on a top of said integrated metering pump;
wherein compressing said lever actuates the dispensing of said toothpaste in a metered discharge amount from said storage container, through said suction tube and said one-way outlet valve, and out of a nozzle;
wherein said nozzle positioned at a terminal end of said lever for the dispensing of said toothpaste;
wherein said nozzle having a diameter from 6.43 mm to 8.52 mm;
wherein the compressing of said lever increases a pressure inside said integrated metering pump for forcing said toothpaste through said suction tube;
wherein said storage container is refillable; and
further wherein said metered discharge amount is from 1.25 g to 1.60 g.

13. The single handed toothpaste pump dispenser of claim 12, wherein said integrated metering pump having a spring inside a pump chamber, and further wherein the compressing of said lever compresses said spring and increases the pressure inside said pump chamber for limiting flow of said toothpaste in one direction.

14. The single handed toothpaste pump dispenser of claim 13, wherein said nozzle having a diameter from 7.20 mm to 8.02 mm.

15. The single handed toothpaste pump dispenser of claim 13, wherein said toothpaste is tooth gel.

16. The single handed toothpaste pump dispenser of claim 14, wherein said integrated metering pump selectively removable from said storage container.

17. The single handed toothpaste pump dispenser of claim 16, wherein said suction tube having a diameter from 6.43 mm to 8.52 mm.

18. A single handed toothpaste pump dispenser comprising:
a pump dispenser having a storage container for holding toothpaste;
an integrated metering pump; and
a lever;
wherein said storage container having a material selected from the group consisting of a transparent material, a translucent material, and an opaque material;
wherein said integrated metering pump operatively connected to a suction tube including a one-way outlet valve;
wherein said suction tube extends to a bottom of said storage container;
wherein said lever mounted on a top of said integrated metering pump;
wherein compressing said lever actuates the dispensing of said toothpaste in a metered discharge amount from said storage container, through said suction tube and said one-way outlet valve, and out of a nozzle;
wherein said nozzle positioned at a terminal end of said lever for the dispensing of said toothpaste;
wherein said nozzle having a diameter from 6.43 mm to 8.52 mm;
wherein said suction tube having a diameter from 6.43 mm to 8.52 mm;
wherein the compressing of said lever increases a pressure inside said integrated metering pump for forcing said toothpaste through said suction tube;
wherein said storage container is refillable;
wherein said metered discharge amount is from 1.00 g to 2.00 g; and
further wherein said integrated metering pump selectively removable from said storage container.

19. The single handed toothpaste pump dispenser of claim 18, wherein said integrated metering pump having a spring inside a pump chamber, and further wherein the compressing of said lever compresses said spring and increases the pressure inside said pump chamber for limiting flow of said toothpaste in one direction.

20. The single handed toothpaste pump dispenser of claim 19, wherein said nozzle having a diameter from 7.20 mm to 8.02 mm.
